(19) United States
(12) Patent Application Publication
(10) Pub. No.: US 2016/0178867 A1
(43) Pub. Date: Jun. 23, 2016

(54) Micro Lens-Driving Apparatus

(71) Applicant: PowerGate Optical Inc., Hsinchu County (TW)

(72) Inventors: YING CHUN HUANG, Zhubei City (TW); WEN TSAI HSU, Zhubei City (TW); YU CHIA CHEN, Zhubei City (TW); CHUANYU HSU, Zhubei City (TW)

(73) Assignee: PowerGate Optical Inc., Hsinchu County (TW)

(21) Appl. No.: 14/951,143

(22) Filed: Nov. 24, 2015

(30) Foreign Application Priority Data
Dec. 18, 2014 (TW) 103222430

(51) Int. Cl. G02B 7/10; G02B 13/00

(52) U.S. Cl. CPC G02B 7/102; G02B 13/009

(57) ABSTRACT

A micro lens-driving apparatus includes an upper cover, a base, a shell frame, a lens module, a plate spring, at least one movable magnet and a coil ring. The upper cover is a hollow cover frame. The base engages the upper cover to form an internal accommodation room. The shell frame ensures the engagement of the upper cover and the base by sleeving. The lens module is located inside the accommodation room. The plate spring adhered to the base is located between the upper cover and the base for elastically restraining linear motion of the lens module. The movable magnet is mounted outside to the lens module. The coil ring is located inside the base peripheral to the accommodation room at a place respective to the movable magnet. The plate spring is adhered into the engagement cavities through a shock-absorbing glue so as to serve anti-shock upon the lens module.

This application claims the benefit of Taiwan Patent Application Serial No. 103222430, filed Dec. 18, 2014, the subject matter of which is incorporated herein by reference.

### BACKGROUND OF INVENTION

1. Field of the Invention

The invention relates to a micro lens-driving apparatus, and more particularly to the lens-driving apparatus that implements a current magnetic field as the power source to perform optical zooming.

2. Description of the Prior Art

Referring now to FIG. 1, a schematic exploded view of a conventional focus lens is shown. In this conventional focus lens, a mechanical focusing mechanism 9 equipped with a precise hi-cost driving member 91 as the power source to drive a carrier case 93 carrying a lens set 92 is applied. In the art, the driving member 91 can be a step motor, a supersonic motor, a piezoelectric actuator or any the like. Also, some other transmission parts are included in this focus lens. These parts usually complicate the apparatus at least in both assembly and volume occupation. In addition, the cost and the energy consumption are problems vet to be overcome.

In the early time, photographic technique is pretty complicated, and needs huge labor work in artificial metering, manual focusing and reeling. Such a magnitude of human involvement usually causes careless but unforgiveable problems, such as a miss for an important unrepeated scene. Hence, at that time, quality and discipline of a photographer are critical for taking a good picture. However, with great prosperity of automatic machines in 50s and 60s, more and more people believed that the automation flagged the future life in all manifolds. An obvious example was the appearance of the auto-metering technique and the auto-reeling technique. Such an improvement in photography made people believed that the photographic technique could be fully automatic some day. One of clues was the “auto focusing system”, which determined the speed of taking pictures and was the mainstream research topics for most of the manufacturers of cameras.

As the related technology grows day by day, conventional professional photographic apparatuses were continuously upgraded in resolution and minimized in weight, thickness, width and length; such that versatile requirements for products in the information age could be met. However, some problems still remained unsolved. For example, the zoom lens driven by a step motor met a difficulty in further reducing the whole volume, and the problem eventually led to a complete failure on the product in further improving the whole size thereof.

On the other hand, manufacturers introduced the electromagnetic technique for an attempt to overcome the aforesaid problems. For example, the VCM (voice coil motor) electronic feedback system, to replace the conventional step motor, was introduced to regulate the coil and thereby able further to reduce the whole volume of the driving structure. Contemporarily, another approach was to integrate products with different functions. For example, one effort was to integrate photographic capacity into the mobile phone, the personal digital assistant (PDA) or the notebook computer so as to produce a powerful electronic apparatus with video functions.

Therefore, to the related manufactures and researchers, with a design of a common power supply, it is now the research issue of how to reduce both the volume and the cost and how to reduce the energy consumption so as to extend the standby time and the service life.

### SUMMARY OF THE INVENTION

Accordingly, it is the primary object of the present invention to provide a micro lens-driving apparatus, which implements the magnetic levitation theory to elastically and magnetically suspend a lens module inside an accommodation room of a base, and further introduces a plate spring to be adhered into engagement cavities on a base via a shock-absorbing glue, such that a magnitude of a shock at the moving lens module supported by the plate spring can be substantially reduced.

It is a further object of the present invention to provide a micro lens-driving apparatus that implements the magnetic induction theory by applying a current to a coil ring so as further to drive the lens module to perform an axial linear displacement inside the accommodation room. Upon such an arrangement in accordance with the present invention, the construction of the conventional step motor in the art can be omitted, so that the number of the elements can be reduced. the occupied volume can be smaller, and the structuring can be much simplified.

In the present invention, the micro lens-driving apparatus defined with a centerline comprises an upper cover, a base, a shell frame, a lens module, a plate spring, at least one movable magnet and a coil ring. The upper cover is formed as a hollow cover frame. The base engages the upper cover so as integrally to form therebetween an internal accommodation room. The shell frame for sleeving the upper cover and the base is to ensure the engagement of the upper cover and the base. The lens module is located inside the accommodation room. The plate spring adhered into engagement cavities on the base is located between the upper cover and the base and is to elastically restrain the lens module to move only inside the accommodation room and along the centerline. The movable magnet is mounted outside to the lens module. The coil ring is located inside the base peripheral to the accommodation room and at a place respective to the movable magnet. In the present invention, the plate spring is adhered into the engagement cavities through a shock-absorbing glue so as to serve anti-shock upon the lens module.

All these objects are achieved by the micro lens-driving apparatus described below.

### BRIEF DESCRIPTION OF THE DRAWINGS

The present invention will now be specified with reference to its preferred embodiment illustrated in the drawings, in which:

FIG. 1 is a schematic exploded view of a conventional focus lens;

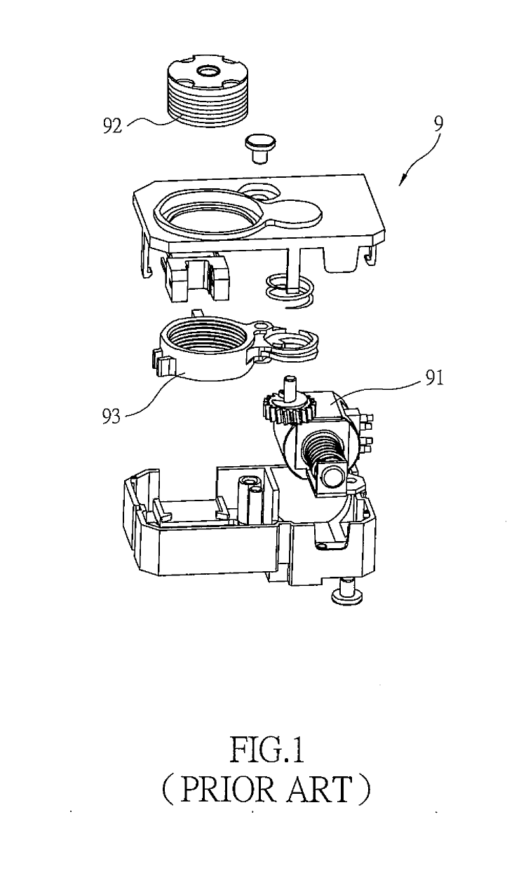

FIG. 2 is a schematic exploded view of a preferred micro lens-driving apparatus in accordance with the present invention:

FIG. 3 is a cross-sectional view of the micro lens-driving apparatus of FIG. 2; and

FIG. 4 is a top view of the plate spring of the micro lens-driving apparatus of FIG. 2.

### DESCRIPTION OF THE PREFERRED EMBODIMENT

The invention disclosed herein is directed to a micro lens-driving apparatus. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

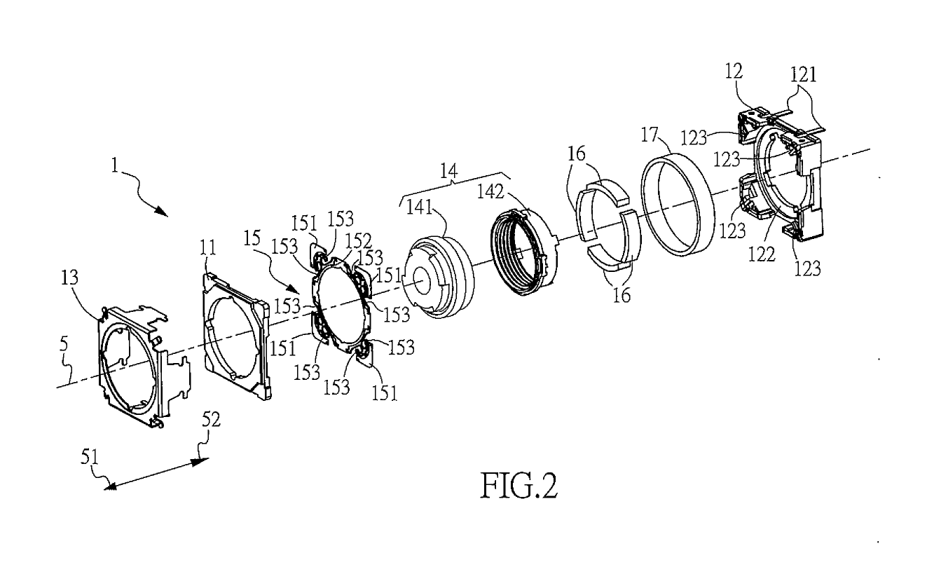

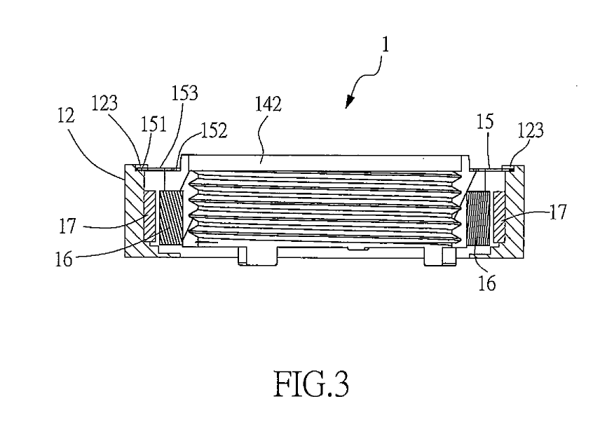

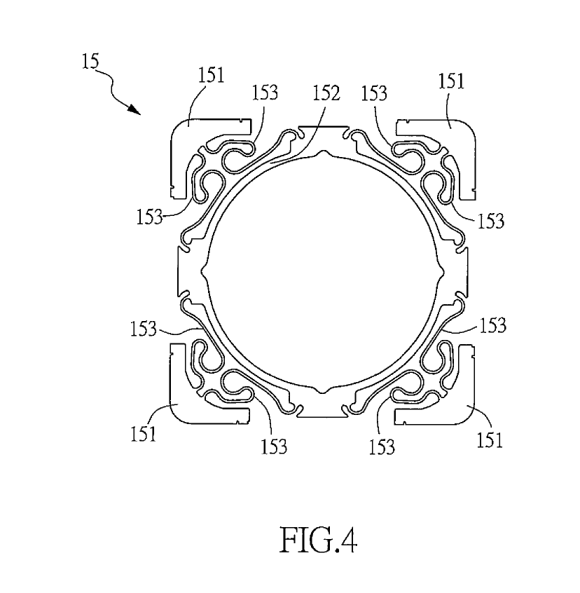

Refer now to FIG. 2, FIG. 3 and FIG. 4; in which FIG. 2 is a schematic exploded view of a preferred micro lens-driving apparatus 1 in accordance with the present invention, FIG. 3 is a cross-sectional view of the micro lens-driving apparatus 1 of FIG. 2, and FIG. 4 is a top view of the plate spring, of the micro lens-driving apparatus of FIG. 2. As shown, the micro lens-driving apparatus 1, defined symmetrically with a centerline 5, includes an upper cover 11, a base 12, a shell frame 13, a lens module 14, a plate spring 15, at least one movable magnet 16, and a coil ring 17. The centerline 5 includes a front direction 51 and a rear direction 52 opposing directionally to the front direction 51.

The upper cover 11 is an annular hollow frame structure. and the base 12 is a hollow block structure with at least one power cable port 121 located at one lateral side thereof. While the upper cover 11 and the base 12 are matched together, a hollow housing structure with an internal accommodation room 122 is constructed. In addition, a plurality of engagement cavities 123 is formed at respective locations (corners in the figure) on top of the base 12. The shell frame 13 is to wrap or sleeve the combination of the upper cover 11 and the base 12 so as to firmly fix the engagement of the combination thereinside.

The lens module 14 is located along the centerline 5 inside the accommodation room 122 in a magnetic levitation manner between the upper cover 11 and the base 12. In the accommodation room 122 (i.e. inside the base 12), the lens module 14 is able to move back and forth along the centerline 5. The lens module 14 further includes a lens 141 and a lens carrier 142. In the present invention, the centerline 5 is exact the optical axis of the lens 141 for focusing. In particular, the lens 141 is located in the center of the lens carrier 142 and moved synchronously with the lens carrier 142. The plate spring 15 is fixed between the upper cover 11 and the base 12 so as to elastically restrain the lens carrier 142 of the lens module 14 inside the accommodation room 122. The plate spring 15 can be fixed into the engagement cavities 123 of the base 12 by a shock-absorbing glue, such that shocks contributed by movement of the lens module 14 along the centerline 5 inside the accommodation room 122 can be substantially reduced in magnitudes (noted that the lens module 14 is held by the inner structure of the plate spring 15.

The plate spring 15 further includes a plurality of outer frames 151, an inner frame 152 and a plurality of connection ribs 153 between the outer frames 151 and the inner frame 152. The plurality of outer frames 151 are evenly arranged in an annular discrete manner outside the inner frame 152. The aforesaid shock-absorbing glue is applied to each of the connection ribs 153 at a place close to the corresponding outer frame 151 so as to have the respective outer frame 151 and the corresponding connection rib 153 to adhere into the respective engagement cavity 123 on the base 12. Since the shock-absorbing glue remains in a thick state to serve a buffer function without locating the connection rib 153 solidly and tightly inside the respective engagement cavity 123, thus tiny movement of the connection rib 153 along the optical axis (the centerline 5) is allowed, and also impulsive energy at the connection rib 153 can be substantially damped. Upon such an arrangement, a purpose of stability with fewer jerks can be contributed to the lens module 14. Each individual outer frame 151 is connected to the inner frame 152 via two twisted and mirror-symmetric connection ribs 153. The inner frame 152 is then fixed to the lens carrier 142. In this embodiment, there are four outer frames 151 located individually to corresponding corners of the plate spring 15, and thus eight (four pairs) connection ribs 153 are applied to establish the connection between the outer frames 151 and the inner frame 152. Upon such an arrangement, the weight of the lens module 14 carried by the inner frame 152 can be evenly distributed to the eight connection ribs 153 and further to the respective outer frames 151. In addition, through the shock-absorbing glue to stick the connection ribs 153 into the corresponding engagement cavities 123 of the base 12, the movement of the lens module 14 along the centerline 5 (i.e. the optical axis) inside the accommodation room 122 can be much stable, and thus quality zooming of the apparatus can thus be achieved. Namely. providing the aforesaid structuring, stability of the lens module 14 can be significantly improved, and the anti-shock advantage for the lens module 14 can be obtained as well.

The movable magnets 16 are mounted at the lens module 14 outside to the lens carrier 142. The coil ring 17 is located inside the base 12 peripheral to the accommodation room 122, and positioned at a place corresponding to the movable magnets 16. The coil ring 17 is also electrically coupled with the power cable ports 121 located at the lateral side of the base 12. In this embodiment, the movable magnets 16 are embodied as at least two pairs of the symmetric permanent magnets (four permanent magnets into two pairs as shown in FIG. 2), two symmetric permanent magnets, six even-distributed permanent magnets or eight even-distributed permanent magnets discretely mounted onto the exterior surface of the lens carrier 142 but inside the coil ring 17.

By energizing the coil ring 17 to produce corresponding magnetic repulsive forcing against the movable magnets 16 and thus the lens module 14, the lens module 14 can then be magnetically levitated along the centerline 5 inside the accommodation room 122 formed between the upper cover 11 and the base 12. Namely, as the coil ring 17 is electrically connected with the power cable ports 121 at the base 12 and is applied by a predetermined current in a specific direction, the lens carrier 142 inside the accommodation room 122 can undergo axial movement along the centerline 5 in the corresponding direction (frontward or rearward) by changes in the induced current magnetic field. Thus, the lens 141 can perform focusing or zooming accordingly.

In summary, the micro lens-driving apparatus 1 of the present invention, defined with a centerline 5, includes an upper cover 11, a base 12, a shell frame 13, a lens module 14, a plate spring 15, at least one movable magnet 16 and a coil ring 17. The upper cover 11 formed as a hollow cover frame is to engage the base 12 so as to produce an internal accommodation room 122 therebetween. The shell frame 13 is to sleeve outside the upper cover 11 and the base 12 so as to ensure the engagement thereof The lens module 14 located inside the accommodation room 122 along the centerline 5 further includes a lens 141 and a lens carrier 142.

The plate spring 15. located between the upper cover 11 and the base 12, is to elastically suspend the lens module 14 inside the accommodation room 122 and along the centerline 5. At least one movable magnet 16 is located outside the lens module 14. The coil ring 17 is located inside the base 12 peripheral to the accommodation room 122 and at a place respective to the at least one movable magnet 16.

The plate spring 15 further includes a plurality of outer frames 151, an inner frame 152 and a plurality of connection ribs 153. The plurality of outer frames 151 is evenly separately arranged outside the inner frame 152 in an annular manner, and each of the outer frames 151 is connected to the inner frame 152 by two winding but mirror-symmetric connection ribs 153. The inner frame 152 is fixed to the lens carrier 142. Each of the connection ribs 153 is adhered, at a place close to the respective outer frame 151, into the corresponding the engagement cavity 123 on the base 12 through a shock-absorbing glue. so as to serve anti-shock upon the lens module 14 during a focusing or zooming adjustment along the centerline 5.

While the present invention has been particularly shown and described with reference to a preferred embodiment, it will be understood by those skilled in the art that various changes in form and detail may be without departing from the spirit and scope of the present invention.

What is claimed is:

1. A micro lens-driving apparatus, defined with a centerline, comprising:
an upper cover, formed as a hollow cover frame:
a base, engaging the upper cover to form therebetween an internal accommodation room:
a shell frame, sleeving the upper cover and the base so as to ensure engagement of the upper cover and the base;
a lens module, located inside the accommodation room;
a plate spring, adhered into engagement cavities on the base, located between the upper cover and the base, being, to elastically restrain the lens module to move only inside the accommodation room and along the centerline;
at least one movable magnet, mounted outside to the lens module; and
a coil ring, located inside the base peripheral to the accommodation room and at a place respective to the at least one movable magnet;
wherein the plate spring is adhered into the engagement cavities through a shock-absorbing glue so as to serve anti-shock upon the lens module.

2. The micro lens-driving apparatus of claim 1, wherein the lens module further includes a lens and a lens carrier, the lens being located at a center of the lens carrier and moving, synchronously with the lens carrier.

3. The micro lens-driving apparatus of claim 1, wherein the at least one movable magnet includes at least two pairs of symmetric permanent magnets even-distributed and discretely mounted onto an exterior surface of the lens carrier and also located respective to the coil ring.

4. The micro lens-driving apparatus of claim 1, wherein the plate spring further includes a plurality of outer frames, an inner frame and a plurality of connection ribs between the outer frames and the inner frame, the plurality of outer frames being evenly arranged in an annular discrete manner outside the inner frame, the outer frame being fixed into the respective engagement cavity on the base, each the outer frame being connected to the inner frame via two of the connection ribs twisted and minor-symmetric, the inner frame being fixed to the lens carrier, the shock-absorbing glue being applied to each of the connection ribs at a place close to the corresponding outer frame so as to have the respective outer frame and the corresponding connection rib to adhere into the respective engagement cavity on the base.

5. The micro lens-driving apparatus of claim 4, wherein the plurality of outer frames includes four said outer frames located individually to corresponding corners of the plate spring, and thus eight of the connection ribs being applied to establish connection between the outer frames and the inner frame.

6. The micro lens-driving apparatus of claim 1, further including at least one power cable ports located at one lateral side of the base.
